(19) United States
(12) Patent Application Publication
(10) Pub. No.: US 2025/0333954 A1
(43) Pub. Date: Oct. 30, 2025

(54) METHOD FOR ASSEMBLING A PARTITION AND ASSEMBLY KIT FOR CARRYING OUT SAID METHOD

(71) Applicant: A. Raymond et Cie, Grenobie (FR)

(72) Inventors: Stéphane Gelibert, Grenoble (FR); Eric Vazart, Grenoble (FR); Olivier Bizzini, Grenoble (FR); Alexis Garnier, Grenoble (FR)

(21) Appl. No.: 19/187,545

(22) Filed: Apr. 23, 2025

(30) Foreign Application Priority Data
Apr. 24, 2024 (FR) 2404231

(51) Int. Cl. E04B 1/38; F16B 2/20

(52) U.S. Cl. CPC E04B 1/388; F16B 2/20

(57) ABSTRACT

A method of assembling a partition against at least one support surface of a planar support, the partition comprising two main surfaces that are substantially parallel and connected for a contour, the contour comprising at least three edge surfaces, the assembly method comprising attaching at least one of the edge surfaces against at least one support surface using attachment means, the attachment means comprising at least one clip and at least one opening delimited by a contour configured to cooperate by snap-fitting with the at least one clip, the at least one clip being attached on one of the support surface or the edge surface in question, while the opening is formed on the other of the support surface or the edge surface.

### CROSS-REFERENCE TO RELATED APPLICATIONS

This application claims the benefit of the filing date of French Patent Application Serial No. FR2404231, filed Apr. 24, 2024, for “METHOD FOR ASSEMBLING A PARTITION AND ASSEMBLY KIT FOR CARRYING OUT THE METHOD,” the disclosure of which is hereby incorporated herein in its entirety by this reference.

### TECHNICAL FIELD

The present disclosure relates to the field of building, and, in particular, the interior layout of a building. More particularly, the present disclosure relates to a method of assembling a partition on a planar support. In particular, according to the present disclosure, the partition is assembled using snap-fitting means.

### BACKGROUND

French Patent Publication FR 2719089 discloses a device for assembling a partition, in particular, a removable partition. This device, as shown in FIG. 4 of document FR 2719089, uses a profile capable of accommodating the edge surface of a partition. More particularly, the profile comprises a gutter into which a rim of the partition is intended to abut. The device described in FR 2719089 also comprises a clip designed to cooperate with the profile to hold the partition in place.

However, this device is not satisfactory.

In fact, after coupling the partition to the profile, this system requires a clip to be fitted to secure the partition to the profile.

Given the size of the partition and the need to temporarily hold it in place, this last step is a source of complexity.

Moreover, the clip, once it has been snap-fitted onto the profile, remains visible and may therefore need to be covered.

The aim of the present disclosure is therefore to propose a method for assembling a partition that is simple to implement, and for which ergonomics are improved compared with solutions known from the state of the art.

A further aim of the present disclosure is to provide a method of assembling a partition wherein handling of the partition is limited after it has been installed.

Another aim of the present disclosure is to provide a kit for assembling a partition.

### BRIEF SUMMARY

The aims of the present disclosure are achieved at least in part by a method for assembling a partition against at least one support surface of a planar support, the partition comprising two main surfaces, which are substantially parallel and connected for a contour, the contour comprising at least three edge surfaces, for example, four edge surfaces, the assembly method comprising attaching at least one of the edge surfaces against at least one support surface using attachment means, the attachment means comprising at least one clip and at least one opening delimited by a contour configured to cooperate by snap-fitting with the at least one clip, the at least one clip being attached on one of the support surface or the edge surface in question, while the opening is formed on the other of the support surface or the edge surface.

According to one embodiment, the attachment of at least one of the edge surfaces against the planar support is preceded by the following steps:
a) attaching the at least one clip on one of the edge surface and the support surface of the support;
b) forming the at least one opening on the other of the edge surface and the support surface;
c) positioning the edge surface opposite the support surface, and then snap-fitting the at least one clip to the at least one contour.

According to one embodiment, the at least one opening is elongate in an elongation direction so as to enable a relative movement, in the elongation direction, of the at least one clip in the opening after performing step c), the assembly method further comprising a step d), subsequent to step c), of adjusting the positioning of the partition, the positioning adjustment comprising a movement of the partition in the elongation direction.

According to one embodiment, the assembly method comprises the attachment of one of the edge surfaces, referred to as the horizontal edge surface, with the support surface, referred to as the horizontal support surface, of a horizontal planar support, and the attachment of another of the edge surfaces, referred to as the lateral edge surface, with the support surface, referred to as the vertical support surface, of a vertical planar support.

According to one embodiment, step a) comprises the screwing or clamping of the at least one clip.

According to one embodiment, step b) comprises cutting the opening on the other of the edge surface and the support surface followed by bending the rim of the opening, the rim forming the contour intended to cooperate with the at least one clip by snap-fitting.

According to one embodiment, step b) comprises carrying out the following sub-steps:
b1) creating a recess opening out via the other of the support surface and the edge surface;
b3) placing a longitudinal plate to cover the recess, the plate comprising the opening, the opening providing access to the recess.

According to one embodiment, step b) also comprises carrying out step b2) interposed between step b1) and step b3), step b2) comprising positioning a disassembly wedge in the recess, the disassembly wedge being capable of adopting either a first position or a second position as soon as it is positioned in the recess, the first position being a neutral position wherein the disassembly wedge remains at a distance from the clip, while the second position is a position wherein the disassembly wedge enables disengagement of the clip from the contour of the opening.

According to one embodiment, the planar support comprises a batten and one surface of which is in alignment with the support surface.

The present disclosure also relates to a kit for assembling a partition against a support surface of a planar support, the partition comprising two main surfaces that are substantially parallel and connected for a contour, the contour comprising at least three edge surfaces, for example, four edge surfaces, the assembly kit comprising:
a clip provided with a base and snap-fitting means that extend from a first surface of the base, the clip being configured to be assembled on one of the support surface or one of the edge surfaces of the contour, referred to as the assembly edge surface, via a second surface of the base and opposite the first surface;
a substantially planar support surface, intended to be secured to the other support surface or the assembly edge surface, the snap-fitting section being provided with an opening, which is elongate in an elongation direction and delimited by a snap-fitting contour configured to cooperate by snap-fitting with the snap-fitting means by engaging the snap-fitting means in the opening via an upper surface of the snap-fitting section in an assembly direction running from the upper surface toward a lower surface of the snap-fitting section opposite the upper surface.

According to one embodiment, the opening has an extension in the elongation direction, which is greater than, advantageously at least two times greater than, the transverse extension of the snap-fitting section so as to enable an adjustment of the positioning of the partition by moving the partition in the extension direction of the opening when the snap-fitting means are in snap-fitting engagement with the snap-fitting contour.

According to one embodiment, the snap-fitting section is formed on the support surface.

According to one embodiment, the snap-fitting section comprises an elongate plate, which extends between its two ends in the elongation direction.

According to one embodiment, the snap-fitting section comprises a central section arranged between two end sections, the end sections being configured to enable the snap-fitting section to be attached against one of the support surface or the assembly edge surface and via the lower surface of the snap-fitting section.

According to one embodiment, the snap-fitting section comprises bends such that the end sections lie in a first plane and the central section lies in a second plane, which is different from the first plane and downstream of the first plane in a direction opposite to the assembly direction.

According to one embodiment, the snap-fitting means comprises two spring fins, each spring fin comprises, in a direction from the first surface to the second surface and referred to as the main direction, a substantially planar first section and a likewise substantially planar second section, the two first sections extending divergently with respect to one another in the main direction, and the two second sections extending convergently with respect to one another in the main direction.

According to one embodiment, the two first sections are arranged such that, upon engagement of the snap-fitting means in the opening in the assembly direction, and upon contact by sliding against the snap-fitting contour, moving the sections toward each other enables complete insertion of the snap-fitting means in the opening.

According to one embodiment, after the first sections pass through the opening, the two second sections are arranged so as to abut against the snap-fitting contour via the lower surface.

According to one embodiment, each spring fin comprises a spring strip that attaches its first section to the base.

According to one embodiment, the spring strip connects a rim of the first section with the base.

According to one embodiment, the base comprises clearance take-up means configured to take up any clearance in the assembly direction.

According to one embodiment, the clearance take-up means comprises tabs that extend from a rim of the base and that are bent in a direction opposite to the main direction, the tabs being configured to bear against the upper surface, and exert a force in a direction opposite to the assembly direction.

According to one embodiment, the assembly kit also comprises a disassembly wedge, the disassembly wedge comprises two mutually parallel main walls each provided with a free rim opposite a bottom of the disassembly wedge, the disassembly wedge being intended to be inserted, via its bottom, into a recess that opens out via one of the support surface or the assembly edge surface, the snap-fitting section being arranged vertically perpendicular to the recess, the disassembly wedge being further configured to adopt either a first position or a second position in the recess in the assembly direction, the first position being a position wherein the free rims are held at a distance from the first sections, the second position being a position wherein each free rim forces the first sections closer together so as to enable the snap-fitting means to be withdrawn in a direction opposite to the assembly direction.

According to one embodiment, the disassembly wedge also comprises two lateral levers that extend from the bottom and in a direction from the bottom toward one of the free rims, and each terminate in a tooth, the two teeth each extending in two opposing directions, the snap-fitting section also comprises two abutments each configured to cooperate with one of the teeth when the disassembly wedge is in its second position.

The present disclosure also relates to a method of assembling a partition on a support surface of a batten, the partition comprising two main surfaces that are substantially parallel and connected for a contour, the contour comprising at least three edge surfaces, for example, four edge surfaces, the method using the assembly kit according to the present disclosure, and the method comprising:
a step of attaching the clip on one of an edge surface, referred to as the assembly edge surface, or a support surface;
a step of forming the snap-fitting section on the other of the assembly edge surface or the support surface;
a step of positioning the assembly edge surface of the partition opposite the support surface so as to engage the snap-fitting means in the opening.

According to one embodiment, wherein the assembly method also comprises forming a recess in the batten, the recess opening out via the support surface, the method comprising the arrangement of the disassembly wedge in the recess, the snap-fitting section being arranged vertically perpendicular to the recess.

### BRIEF DESCRIPTION OF THE DRAWINGS

Other features and advantages of the present disclosure will emerge from the following detailed description of the present disclosure with reference to the appended figures, wherein:

FIG. 1 is a schematic representation, in a perspective view, of a partition and a planar support that can be considered in the context of the present disclosure;

FIG. 2 is a schematic perspective view of a clip conforming to the principles of the present disclosure;

FIG. 3 is a schematic perspective view of an opening according to the disclosed principles of the present disclosure;

FIG. 4 is a schematic representation of the clip from FIG. 2 assembled on the assembly edge surface;

FIG. 5 is a schematic perspective view of a plate conforming to the principles of the present disclosure;

FIG. 6 is a schematic perspective view of another plate conforming to the disclosed principles of the present disclosure;

FIG. 7 is a schematic representation of the plate shown in FIG. 6 assembled on the support surface;

FIG. 8 is a schematic representation of a partition; in particular, FIG. 8 shows the assembly of clips and plates on the edge surfaces of the partition;

FIG. 9 is a schematic representation of a clip and plate assembly on a horizontal support surface and on a vertical support surface;

FIG. 10 is a schematic representation of the engagement of clips, arranged on the horizontal support surface, in the openings of plates attached to a horizontal edge surface;

FIG. 11 is a schematic representation of the snap-fitting of clips, arranged on the horizontal support surface, with the openings of plates attached to a horizontal edge surface;

FIG. 12 is a schematic representation of the snap-fitting of clips, arranged on the vertical support surface, with the plate openings attached on a vertical edge surface, the snap-fitting being obtained by adjusting the partition positioning;

FIG. 13 is a schematic representation of a disassembly wedge arranged in the recess;

FIG. 14 is a schematic representation of an isolated disassembly wedge;

FIG. 15 is a schematic representation of a disassembly wedge in its first position in the recess;

FIG. 16 is a schematic representation of a disassembly wedge in the recess and in its second position; and

FIG. 17 is a schematic representation of a further clip in accordance with the principles of the present disclosure and in perspective view.

### DETAILED DESCRIPTION

According to a first aspect, the present disclosure relates to a method of assembling a partition on a support surface of a planar support. In particular, the present disclosure relates to the use of attachment means to assemble the partition against the support surface by a simple snap-fitting. According to this first aspect, the attachment means are formed/attached on one and the other of an edge surface, referred to as the support edge surface of the partition, and the support surface. Owing to the present disclosure, in particular, in the final stage of the method, the partition is positioned and secured to the support surface.

It is understood that the dressing, decoration and finishing stages can be carried out once the partition has been positioned and secured to the support surface.

It is understood that an edge surface is a substantially planar lateral surface of the partition.

Thus, according to a first aspect, the present disclosure relates to a method for assembling a partition against at least one support surface of a planar support, the partition comprising two main surfaces, which are substantially parallel and connected for a contour, the contour comprising four edge surfaces, the assembly method comprising attaching at least one of the edge surfaces against at least one support surface using attachment means, the attachment means comprising at least one clip and at least one opening delimited by a contour configured to cooperate by snap-fitting with the at least one clip, the at least one clip being attached on one of the support surface and the edge surface in question, while the opening is formed on the other of the support surface and the edge surface.

According to this first aspect, the present disclosure uses attachment means assembled respectively on one or another of the edge surfaces and the support surface. Still according to this first aspect, the attachment means are attached/formed prior to positioning the partition, and, in particular, the edge surface in question, on the support surface.

According to one variant, the present disclosure also provides that the opening is formed on the support surface. In particular, forming an opening can involve removing material, drilling, stamping, punching or any other operation that may lead to the formation of an opening. In this respect, the planar support, according to this variant, can comprise a metal beam provided with a central, substantially planar section, the central section having a surface aligned with the support surface. For example, a punching step can be performed on the support surface of the beam to form the opening.

According to another variant, an additional part can be positioned to form the opening. In particular, the additional part can comprise the fitting and/or attachment of a snap-fitting section on the support surface. More particularly, the snap-fitting section comprises an elongated plate extending between its two ends in an elongation direction, the plate comprising the opening. In particular, the plate comprises two surfaces opposite one another, referred to as the upper surface and lower surface, respectively. Advantageously, it is also possible to create a recess opening through the support surface (it may, however, be considered to create the recess in the partition and opening through an edge surface). Under these conditions, the plate can be placed over the recess by its lower surface, the plate comprising the opening, the opening giving access to the recess.

The snap-fitting section (in other words, the plate) comprises a central section arranged between two end sections, the end sections being configured to enable the snap-fitting section to be attached against one of the support surface and the assembly edge surface and via the lower surface of the snap-fitting section.

The opening is delimited by a snap-fitting contour configured to cooperate by snap-fitting with the snap-fitting means by engaging the snap-fitting means in the opening via the upper surface of the snap-fitting section in an assembly direction running from the upper surface toward a lower surface of the snap-fitting section opposite the upper surface.

Advantageously, the opening has an extension in the elongation direction, which is greater than, advantageously at least two times greater than, the transverse extension of the snap-fitting section so as to enable an adjustment of the positioning of the partition by moving the partition in the extension direction of the opening when the snap-fitting means are in snap-fitting engagement with the snap-fitting contour. Still advantageously, the snap-fitting section may comprise bends such that the end sections lie in a first plane and the central section lies in a second plane, which is different from the first plane and downstream of the first plane in a direction opposite to the assembly direction.

According to the first aspect, the method may then comprise performing the following steps:
a) attaching the at least one clip on one of the edge surface and the support surface of the support;
b) forming the at least one opening on the other of the edge surface and the support surface;
c) positioning the edge surface opposite the support surface, and then snap-fitting the at least one clip to the at least one contour.

Attaching the clip may involve the use of fasteners, such as screws.

In this respect, the clip can be provided with a base and snap-fitting means extending from a first surface of the base. The base also comprises a second surface, opposite the first surface, by which the clip can be assembled on one of the edge surface and the support surface of the support.

The base can be provided with holes enabling the clip to be attached to one of the edge surface and the support surface of the support using screws, for example.

The snap-fitting means may comprise two spring fins. In particular, each spring fin can comprise, in a direction running from the first surface to the second surface and referred to as the main direction, a first substantially planar section and a second section, which is also substantially planar. The first two sections extend divergently relative to one another in the main direction, and the second two sections extend convergently relative to one another in the main direction.

Particularly advantageously, the two first sections are arranged such that, upon engagement of the snap-fitting means in the opening, and upon contact by sliding against the contour of the opening (referred to as the snap-fitting contour), moving the sections toward each other enables complete insertion of the snap-fitting means in the opening.

Also advantageously, the two second sections can be arranged so that, after passing through the opening of the first sections, they abut against the snap-fit contour.

Each spring fin can comprise a spring strip that attaches its first section to the base. In particular, the spring strip can connect a rim of the first section with the base.

Advantageously, the base comprises clearance take-up means configured to compensate for any clearance along the assembly direction defined in the following disclosure of the present disclosure. The clearance take-up means may comprise tabs that extend from a rim of the base and, which are bent in a direction opposite to the main direction, the tabs being configured to bear against the upper surface, and exert a force in a direction opposite to the assembly direction.

Advantageously, the at least one opening is elongate in an elongation direction so as to enable a relative movement, in the elongation direction, of the at least one clip in the opening after performing step c), the assembly method further comprising a step d), subsequent to step c), of adjusting the positioning of the partition, the positioning adjustment comprising a movement of the partition in the elongation direction. This latter aspect facilitates assembly, and, in particular, the positioning and subsequent snap-fitting of the partition at least at two different (and non-parallel) edge surfaces.

According to a second aspect, the present disclosure relates to a kit for assembling a partition against a support surface of a planar support, the partition comprising two main surfaces that are substantially parallel and connected for a contour, the contour comprising four edge surfaces, the assembly kit comprising:
a clip provided with a base and snap-fitting means that extend from a first surface of the base, the clip being configured to be assembled on one of the support surface or one of the edge surfaces of the contour, referred to as the assembly edge surface, via a second surface of the base and opposite the first surface;
a substantially planar support surface, intended to be secured to the other support surface and the assembly edge surface, the snap-fitting section being provided with an opening that is elongate in an elongation direction and delimited by a snap-fitting contour configured to cooperate by snap-fitting with the snap-fitting means by engaging the snap-fitting means in the opening via an upper surface of the snap-fitting section in an assembly direction running from the upper surface toward a lower surface of the snap-fitting section opposite the upper surface.

This second aspect reiterates the features described in relation to the first aspect.

The present disclosure also relates to a third aspect relating to the implementation of the assembly kit.

More particularly, the present disclosure also relates to a method of assembling a partition on a supporting surface of a batten, the partition comprising two main surfaces that are substantially parallel and connected for a contour, the contour comprising four edge surfaces, the method implementing the assembly kit, and the method comprising:
a step of attaching the clip on an edge surface, referred to as the assembly edge surface, of the partition;
a step for forming the snap-fitting section on the support surface of the batten; and
a step of positioning the assembly edge surface of the partition opposite the support surface so as to engage the snap-fitting means in the opening.

The following disclosure of the present disclosure provides a detailed description of examples relating to the various aspects described above.

The following disclosure describes the various stages of a method for assembling a partition against at least one support. It is understood that a partition within the meaning of the present disclosure may comprise a room divider or a facade of a room wall.

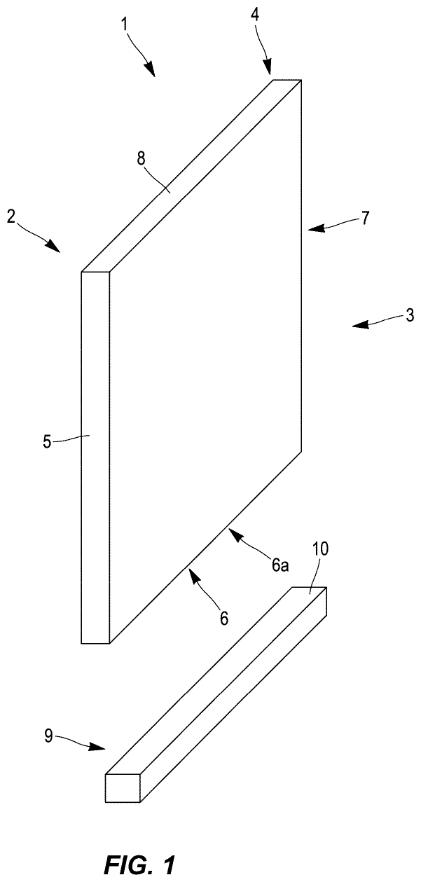

Furthermore, the partition 1, as shown in FIG. 1, comprises two main surfaces 2 and 3, the main surfaces 2 and 3 being connected by a contour 4, the partition having the shape of a rectangular parallelepiped. In this respect, the contour comprises four edge surfaces 5, 6, 7, 8, shaped so that two adjacent edge surfaces are perpendicular.

The partition can comprise any type of material, in particular, wood.

The method according to the present disclosure comprises providing the partition 1 and a support surface 10 of a planar support 9. The planar support 9 can comprise another partition, a batten, a skirting board, a room floor or a dividing wall.

Furthermore, when the planar support comprises a partition, the support surface can be either an edge surface or the main surface of the partition in question.

The method according to the present disclosure is designed to assemble the partition 1 against the support surface 10 of the planar support 9. In particular, this assembly uses attachment means, the attachment means comprising at least one clip and at least one opening delimited by a contour, known as the snap-fitting contour. According to the present disclosure, the snap-fitting contour is configured to cooperate by snap-fitting with the at least one clip.

In this way, the at least one clip can be attached to one of the support surface and one of the four edge surfaces, known as the assembly edge surface, while the opening can be formed on the other of the support surface and the assembly edge surface.

For example, the at least one clip can be assembled on the assembly edge surface and the opening formed on the support surface.

The rest of the present disclosure is limited to the simple consideration of a clip assembled on the assembly edge surface and an opening formed on a support surface. However, the present disclosure is not limited to this aspect alone, and the skilled person may consider the reverse situation.

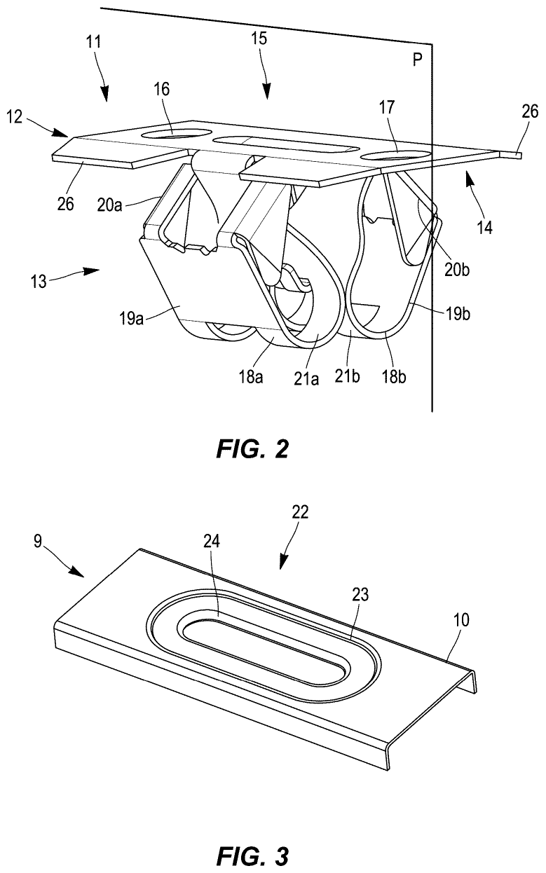

FIG. 2 shows an example of a clip 11 that can be used to implement the method described in the present disclosure.

The clip 11 comprises a base 12 and snap-fitting means 13. The base 12 is generally planar and comprises two opposing surfaces, referred to as first surface 14 and second surface 15, respectively.

The first surface 14 is a surface from which the snap-fitting means 13 extend, while the second surface 15 is a surface by which the clip is intended to be assembled against the assembly edge surface. In particular, the base can comprise holes 16 and 17 for screwing the clip to the assembly edge surface. The clip can also be assembled on the assembly edge surface by means of spikes projecting with respect to the second surface 15.

The snap-fitting means 13 comprise two spring fins 18a and 18b. In particular, the two spring fins 18a and 18b are symmetrical to one another with respect to a plane of symmetry P, the plane of symmetry P being perpendicular to the first surface 14.

More particularly, each spring fin 18a and 18b can comprise, in a direction running from the first surface 14 to the second surface 15 and referred to as the main direction, a substantially planar first section 19a, 19b and a substantially planar second section 20a, 20b.

The first two sections 19a and 19b extend divergently relative to one another in the main direction, and the second two sections 20a and 20b extend convergently relative to one another in the main direction.

“Extend divergently in the main direction” is understood to mean that the distance between the first two sections increases along the direction.

“Extend convergently in the main direction” is understood to mean that the distance between the two second sections decreases along the direction.

Each spring fin 18a and 18b can comprise a spring strip 21a, 21b, which attaches its first section 19a, 19b to the base. The spring strip 21a, 21b may comprise a corrugated metal strip giving the spring strip its spring properties.

Thus, and this aspect will appear clearly in the remainder of the description, the two first sections 19a and 19b are arranged such that, upon engagement of the snap-fitting means in the opening in the assembly direction, and upon contact by sliding against the snap-fitting contour, moving the sections toward each other enables complete insertion of the snap-fitting means in the opening.

FIG. 17 shows another clip capable of being implemented within the scope of the present disclosure.

In particular, like the clip that is shown in FIG. 2, this other clip 11 also comprises a base 12 and snap-fitting means 13.

The ends of the base 12 may comprise alignment notches 12a and 12b to ensure clip alignment during assembly.

The snap-fitting means can be the same as those of the clip shown in FIG. 2. The base 12 is generally planar and comprises two opposing surfaces, referred to as first surface 14 and second surface 15, respectively.

The first surface 14 is a surface from which the snap-fitting means 13 extend, while the second surface 15 is a surface by which the clip is intended to be assembled against the assembly edge surface or against the support surface of the planar support 9.

In particular, the base can comprise holes 16 and 17 for assembling the clip against the assembly edge surface using fastening means (e.g., screws, rivets, clips, etc.).

The clip 11 comprises two side walls 44 that extend from the first surface 14, advantageously perpendicular to the first surface 14, and terminate in two converging walls 45. In particular, each converging wall 45 extends a side wall 44 from a rim of the side wall 44. It is understood that the converging walls 45 each extend a side wall 44 from a rim of the side wall 44 opposite the second surface 15. It is understood that the converging walls 45 converge toward one another.

The snap-fitting means 13 comprise two spring fins 18a and 18b. The two spring fins 18a and 18b are notably symmetrical to one another with respect to a plane of symmetry P, the plane of symmetry P being perpendicular to the first surface 14, and originate at the junction of one of the side walls and a converging wall, and extend toward the first surface 14.

More particularly, each spring fin 18a and 18b can comprise, in a direction running from the first surface 14 to the second surface 15 and referred to as the main direction, a substantially planar first section 19a, 19b and a substantially planar second section 20a, 20b. Each spring fin 18a and 18b can comprise, from its start to its end, a first planar section and a second planar section. The first planar sections extend divergently with respect to one another, and the second planar sections extend convergently with respect to one another.

The clip 11 may also comprise anti-shear cleats 46. In particular, these anti-shear cleats 46, of which there are four, are arranged in pairs on both sides of the side walls 44. In particular, a pair of anti-shear cleats 46, parallel to the side walls 44, each extend from two opposite rims of the base. Each anti-shear cleat 46 may terminate in an inwardly folded section.

FIG. 3 is a schematic representation of an opening according to the disclosed principles of the present disclosure. In particular, the opening 22 shown in FIG. 3 is obtained directly by removing material from the support surface of the planar support. In this case, the planar support 9 comprises a metal beam or batten with a rectangular or square cross-section. Material removal can involve any technique known to the skilled worker in the field of metal structure shaping.

Thus, forming the opening 22 may involve drilling, stamping, punching or any other operation likely to lead to the formation of the opening 22.

FIG. 3 also shows a stamped area 23 formed around the periphery of the opening, designed, in particular, to provide mechanical reinforcement for the support surface 10. In particular, the stamped area 23 is set back from the support surface 10.

The opening 22 is delimited by a contour, known as the snap-fitting contour 24, configured to cooperate with the clip 11 by snap-fitting.

In particular, cooperation between the clip 11 and the snap-fitting contour 24 comprises engagement of the clip 11 in the opening 22 through the support surface 10. During this engagement, the divergence of the first sections 19a, 19b reduces as the engagement progresses until the second sections 20a, 20b reach the snap-fitting contour 24. The second sections 20a, 20b then pass through the opening 22, allowing the first sections 19a, 19b to move apart as they converge. After passing through the opening 22, the second sections slide against the snap-fitting contour from a surface opposite the front surface.

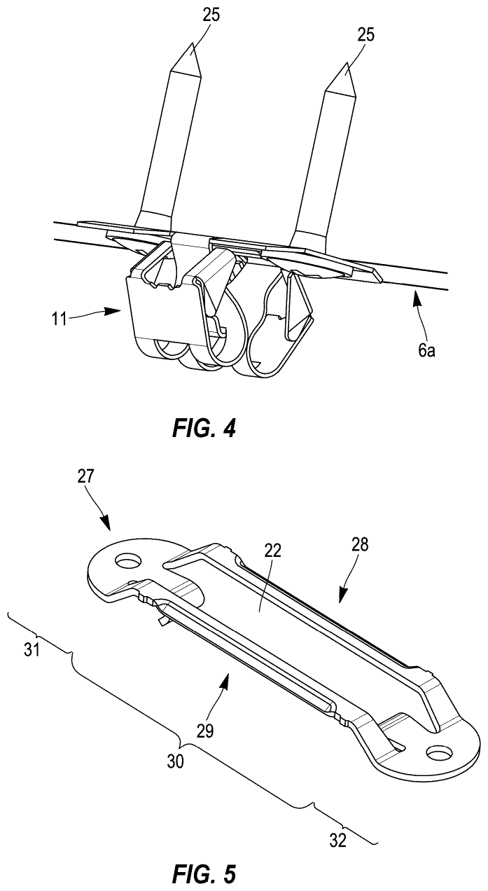

Thus, the attachment of the assembly edge surface according to the terms of the present disclosure can be preceded by the following steps:
a) attaching the clip 11 to the assembly edge surface (FIG. 4);
b) forming the opening 22 on the support surface (FIG. 3);
c) positioning the assembly edge surface opposite the support surface, and then snap-fitting the clip to the snap-fitting contour.

In step a), screws 25 are attached to the assembly edge surface 6a.

Advantageously, the base 12 of the clip 11 comprises clearance take-up means configured to compensate for any clearance in the assembly direction. In particular, the clearance take-up means comprises tabs 26 (FIG. 2) that extend from a rim of the base 12 and that are bent in a direction opposite to the main direction, the tabs being configured to bear against the support surface, and to exert a force in a direction opposite to the assembly direction.

According to a variant of the present disclosure, forming the opening 22 may involve placing a plate 27 on the support surface 10 of the planar support 9 (FIG. 7).

In this respect, the plate 27 may comprise an upper surface 28 and a lower surface 29 and comprise the opening 22. In particular, the elongated plate 27 extends between two ends in an elongation direction. More particularly, the plate 27 may comprise a central section 30 and two end sections 31, 32, the end sections being configured to enable the snap-fitting section to be attached against the support surface by the underside of the plate 27. It is understood that the opening 22 is carried by the central section 30.

In this way, step b) can comprise a step b3) of placing the plate 27, with its lower surface 29, against the support surface 10. The installation of the plate 27 may comprise a screwing step.

In addition, step b) can also comprise, prior to step b3), the creation of a recess 33 opening out through the support surface and the assembly edge surface (step b1)). According to the latter aspect, step b3) is performed so that the plate overlaps the recess 33, and the opening provides access to the recess.

As shown in FIGS. 5-7, the plate 27 may comprise bends such that the end sections 31 and 32 lie in a first plane and the central section 30 lies in a second plane that is different from the first plane and downstream of the first plane in a direction opposite to the assembly direction.

According to an advantageous embodiment, the opening is elongated along an elongation direction so as to allow relative displacement, in the elongation direction, of the clip in the opening after step c) has been carried out. In particular, this last aspect makes it possible to consider a step d), following step c), for adjusting the positioning of the partition, the positioning adjustment comprising a displacement of the partition in the elongation direction.

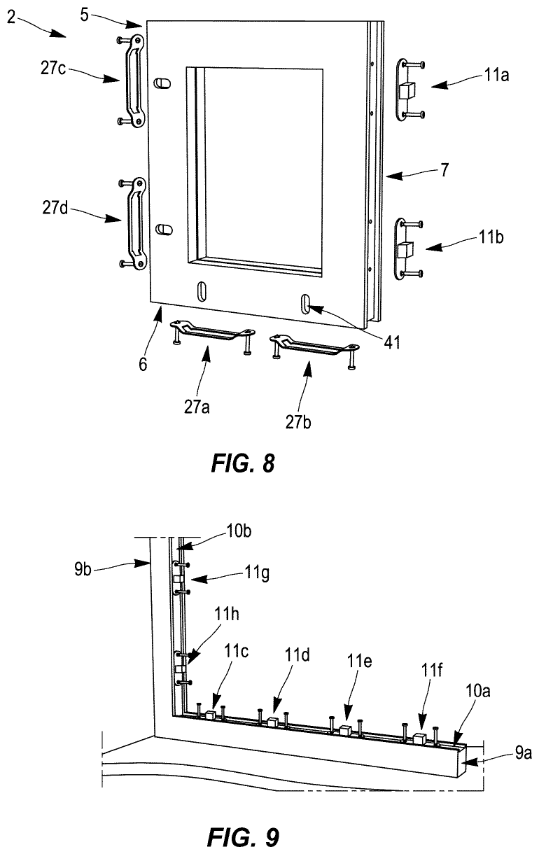

For example, FIG. 8 shows the installation of two plates 27a, 27b on the edge surface 6 (hereinafter “horizontal edge surface”), two other plates 27c, 27d on the edge surface 5 (hereinafter “vertical edge surface”), and two clips 11a and 11b on the edge surface 7 (hereinafter “other vertical edge surface”) of a partition 2.

FIG. 9 schematically shows the positioning of clips 11c, 11d, 11e and 11f on a support surface 10a (hereinafter “horizontal support surface”) of a horizontal planar support 9a. FIG. 9 also shows the positioning of clips 11g and 11h on a support surface 10b (hereinafter “vertical support surface”) of a vertical planar support 9b, the vertical planar support 9b forming a right angle with the horizontal planar support 9a.

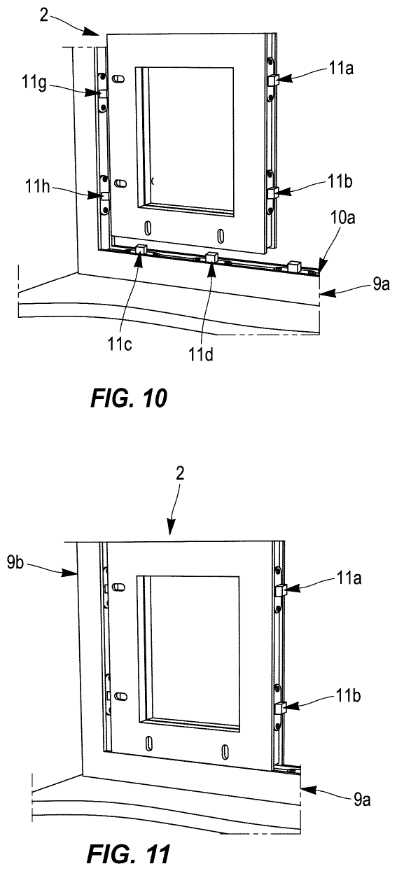

FIGS. 10 and 11 show the assembly of the partition 2 against the horizontal support surface 10a. In particular, and as shown in FIG. 10, the horizontal edge surface is arranged opposite the horizontal support surface, and so as to enable the clip 11c to engage with the plate 27a and the clip 11d to engage with the plate 27b (shown in FIGS. 8 and 9). FIG. 10 shows the end of the engagement and subsequent snap-fitting of the clip 11c with the plate 27a and of the clip 11d with the plate 27b.

In FIGS. 8 and 9, the vertical surface remains at a distance from the vertical support surface. Consideration of an elongated opening in the plates 27a and 27b thus may also enable the partition to be moved after the clip 11c has been engaged with the plate 27a and the clip 11d has been engaged with the plate 27b.

In this respect, the opening of the plates 27a and 27b may have an extension in the elongation direction greater than, and advantageously at least twice, the transverse extent of the snap-fitting section of the clips 11c and 11d.

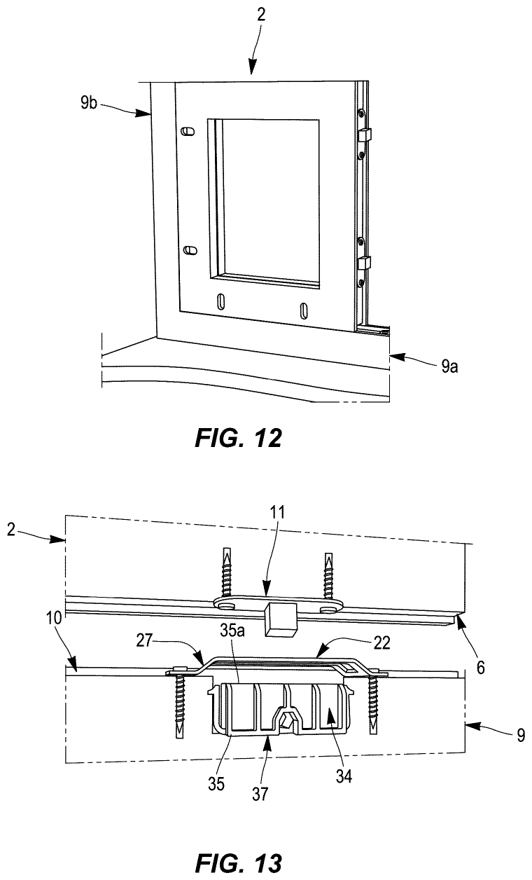

This last aspect thus enables the positioning of the partition 2 to be adjusted, tending to bring the vertical edge surface 5 closer to the vertical support surface 10b so as to engage, on the one hand, the clip 11g in the plate 27c and, on the other hand, the clip 11h in the plate 27d (FIGS. 11 and 12).

In a particularly advantageous embodiment, a disassembly wedge 34 may be considered. In particular, and as shown in FIG. 13, the disassembly wedge 34 can be arranged in the recess 33.

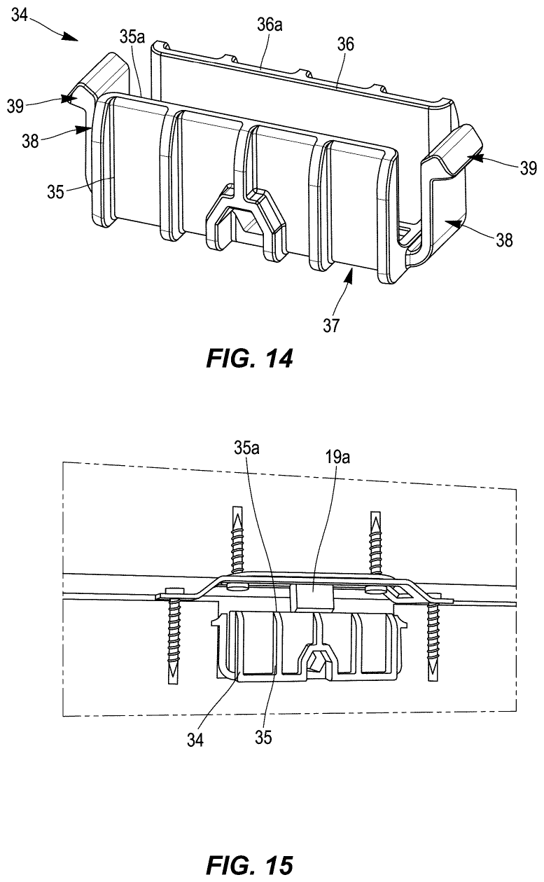

As shown in FIG. 14, the disassembly wedge 34 comprises two main walls 35, 36 parallel to one another, each provided with a free rim 35a and 36a opposite a bottom 37 of the disassembly wedge.

In particular, and as shown in FIG. 13, the disassembly wedge 34 is configured to be inserted, by its bottom 37, into the recess 33. In particular, the disassembly wedge 34 is designed to be inserted into the recess 33 through its bottom 37, so that the opening 22 of the plate 27 is plumb with a surface of the disassembly wedge opposite the bottom 37.

Furthermore, the disassembly wedge 34 is configured to adopt one or another of a first position and a second position in the recess along the assembly direction.

In particular, the first position, shown in FIG. 15, is one wherein the free rims 35a and 36a are held at a distance from the first sections 19a and 19b.

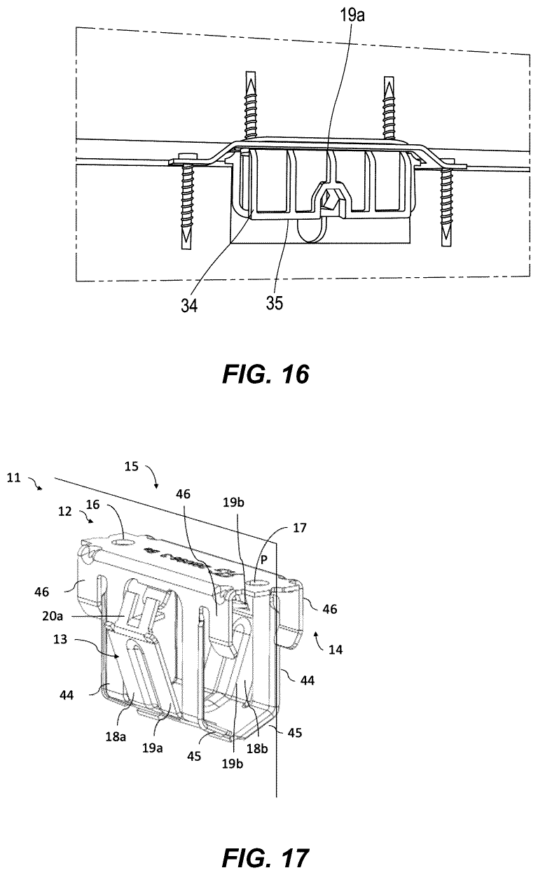

The second position is one wherein each free rim 35a and 36a forces the first sections together so as to allow the snap-fitting means to be withdrawn in a direction opposite the assembly direction shown in FIG. 16.

In particular, moving from the first position to the second position of the disassembly wedge 34 involves moving the wedge in a direction opposite the assembly direction, while moving from the second position to the first position involves moving the disassembly wedge in the recess in the assembly direction.

The disassembly wedge may also comprise two lateral levers 38 that extend from the bottom 37 in a direction from the bottom 37 toward one of the free rims 35a, 36a, and each terminate in a tooth 39. The two teeth 39 each extend in two opposite directions.

It is understood that the lateral levers each extend along a surface, known as the lateral surface, of the disassembly wedge, which is specific to them and opposite one another. In particular, the two side surfaces are perpendicular to the main walls 35 and 36.

The plate 27 may comprise stop means extending from the underside of the plate, intended to cooperate with the teeth 39. In particular, the abutment means 40 (FIG. 7) can be configured to enable the disassembly wedge to be held in the second position by cooperation of the abutment means 40 with the teeth 39.

In particular, the abutment means, as shown in FIGS. 5 and 7, can comprise two lamellae, known as abutment lamellae 42 and 43, that extend from their origin, from the end section 31 and the end section 32, respectively. In particular, the abutment lamellae 42 and 43 extend toward one another substantially parallel to the central section 30. As shown in FIG. 7, the abutment lamellae end in a rounded section in the assembly direction.

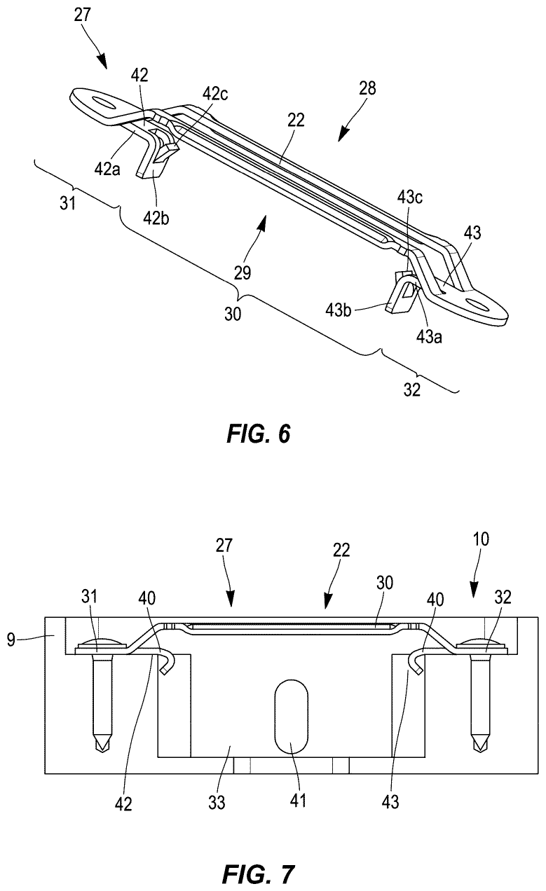

Alternatively, as shown in FIG. 6, each abutment lamella 42, 43 can comprise, from its origin toward its free end, a first part 42a, 43a and a second part 42b, 43b. The two first parts 42a, 43a extend toward one another, while the two second parts 42b, 43b extend from a first part 42a, 43a in the assembly direction. Each abutment lamella 42, 43 may also comprise a cleat 42c, 43c. The cleats 42c, 43c extend convergently in a direction opposite the assembly direction and each from one of the second parts 42b, 43b.

In particular, the cleats 42c, 43c are configured to form abutment means cooperating with the teeth.

Finally, the changeover from one of the first position and the second position to the other of these two positions can be controlled via a tool designed to act directly on the disassembly wedge. In particular, the tool can comprise a rod designed to be inserted into a circular or oblong opening 41, giving access to the disassembly wedge, and made in the partition or planar support. In particular, the tool can act on the bottom of the disassembly wedge. According to this aspect, the opening 41 can be made from a surface of the planar support opposite the support surface. According to another aspect, the opening can be arranged on a flank of the planar support and therefore be oblong in shape.

The present disclosure also relates to a kit for assembling a partition against a support surface of a planar support, the partition comprising two main surfaces that are substantially parallel and connected for a contour, the contour comprising at least three edge surfaces, for example, four edge surfaces, the assembly kit comprising:
a clip provided with a base and snap-fitting means, which extend from a first surface of the base, the clip being configured to be assembled on one of the support surface or one of the edge surfaces of the contour, referred to as the assembly edge surface, via a second surface of the base and opposite the first surface;
a snap-fitting section that is substantially planar and intended to be rigidly connected to the other of the support surface or the assembly edge surface, the snap-fitting section being provided with an opening that is elongate in an elongation direction and delimited by a snap-fitting contour configured to cooperate by snap-fitting with the snap-fitting means by engaging the snap-fitting means in the opening via an upper surface of the snap-fitting section in an assembly direction running from the upper surface toward a lower surface of the snap-fitting section opposite the upper surface.

In particular, this assembly kit may incorporate some or all of the features described in connection with the assembly method.

The present disclosure also relates to the use of the kit for the assembly of a partition.

Of course, the present disclosure is not limited to the described embodiments, and it is possible to add variants thereto without departing from the scope of the invention as defined by the claims.

What is claimed is:

1. A method of assembling a partition against at least one support surface of a planar support, the partition comprising two main surfaces that are substantially parallel and connected for a contour, the contour comprising at least three edge surfaces, the assembly method comprising the attachment of at least one of the edge surfaces against at least one support surface using attachment means, the attachment means comprising at least one clip and at least one opening delimited by a contour configured to cooperate by snap-fitting with the at least one clip, the at least one clip being attached on one of the support surface or the edge surface in question, while the opening is formed on the other of the support surface or the edge surface.

2. The assembly method of claim 1, wherein the attachment of at least one of the edge surfaces against the planar support is preceded by the following steps:
a) attaching the at least one clip on one of the edge surface and the support surface of the support;
b) forming the at least one opening on the other of the edge surface and the support surface; and
c) positioning the edge surface opposite the support surface, and then snap-fitting the at least one clip to the at least one contour.

3. The assembly method of claim 2, wherein the at least one opening is elongate in an elongation direction so as to enable a relative movement, in the elongation direction, of the at least one clip in the opening after performing step c), the assembly method further comprising a step d), subsequent to step c), of adjusting the positioning of the partition, the positioning adjustment comprising a movement of the partition in the elongation direction.

4. The assembly method of claim 2, further comprising the attachment of one of the edge surfaces, referred to as the horizontal edge surface, with the support surface, referred to as the horizontal support surface, of a horizontal planar support, and the attachment of another of the edge surfaces, referred to as the lateral edge surface, with the support surface, referred to as the vertical support surface, of a vertical planar support.

5. The assembly method of claim 2, wherein step a) comprises the screwing or clamping of the at least one clip.

6. The assembly method of claim 2, wherein step b) comprises cutting the opening on the other of the edge surface and the support surface followed by bending the rim of the opening, the rim forming the contour intended to cooperate with the at least one clip by snap-fitting.

7. The assembly method of claim 2, wherein step b) comprises carrying out the following sub-steps:
b1) creating a recess opening out via the other of the support surface and the edge surface; and
b3) placing a longitudinal plate to cover the recess, the plate comprising the opening, the opening providing access to the recess.

8. The assembly method of claim 7, wherein step b) also comprises carrying out step b2) interposed between step b1) and step b3), the step b2) comprising positioning a disassembly wedge in the recess, the disassembly wedge being capable of adopting either a first position or a second position as soon as it is positioned in the recess, the first position being a neutral position in which the disassembly wedge remains at a distance from the clip, while the second position is a position in which the disassembly wedge enables disengagement of the clip from the contour of the opening.

9. The assembly method of claim 1, wherein the planar support comprises a batten and one surface of which is in alignment with the support surface.

10. A kit for assembling a partition against a support surface of a planar support, the partition comprising two main surfaces that are substantially parallel and connected for a contour, the contour comprising at least three edge surfaces, the assembly kit comprising:
a clip provided with a base and snap-fitting means that extend from a first surface of the base, the clip being configured to be assembled on one of the support surface or one of the edge surfaces of the contour, referred to as the assembly edge surface, via a second surface of the base and opposite the first surface;
a snap-fitting section that is substantially planar and intended to be rigidly connected to the other of the support surface or the assembly edge surface, the snap-fitting section being provided with an opening that is elongate in an elongation direction and delimited by a snap-fitting contour configured to cooperate by snap-fitting with the snap-fitting means by engaging the snap-fitting means in the opening via an upper surface of the snap-fitting section in an assembly direction running from the upper surface toward a lower surface of the snap-fitting section opposite the upper surface.

11. The assembly kit of claim 10, wherein the opening has an extension in the elongation direction that is greater than the transverse extension of the snap-fitting section so as to enable an adjustment of the positioning of the partition by moving the partition in the extension direction of the opening when the snap-fitting means are in snap-fitting engagement with the snap-fitting contour.

12. The assembly kit of claim 10, wherein the snap-fitting section is formed on the support surface.

13. The assembly kit of claim 10, wherein the snap-fitting section comprises an elongate plate that extends between its two ends in the elongation direction.

14. The assembly kit of claim 13, wherein the snap-fitting section comprises a central section arranged between two end sections, the end sections being configured to enable the snap-fitting section to be attached against one of the support surface or the assembly edge surface and via the lower surface of the snap-fitting section.

15. The assembly kit of claim 14, wherein the snap-fitting section comprises bends such that the end sections lie in a first plane and the central section lies in a second plane that is different from the first plane and downstream of the first plane in a direction opposite to the assembly direction.

16. The assembly kit of claim 10, wherein the snap-fitting means comprises two spring fins, each spring fin of the two spring fins comprising, in a direction from the first surface to the second surface and referred to as the main direction, a substantially planar first section and a likewise substantially planar second section, the two first sections extending divergently with respect to one another in the main direction, and the two second sections extending convergently with respect to one another in the main direction.

17. The assembly kit of claim 16, wherein the two first sections are arranged such that, upon engagement of the snap-fitting means in the opening in the assembly direction, and upon contact by sliding against the snap-fitting contour, moving the sections toward each other enables complete insertion of the snap-fitting means in the opening.

18. The assembly kit of claim 16, wherein, after the first sections pass through the opening, the two second sections are arranged so as to abut against the snap-fitting contour via the lower surface.

19. The assembly kit of claim 16, wherein each spring fin of the two spring fins comprises a spring strip securing its first section to the base.

20. The assembly kit of claim 19, wherein the spring strip connects a rim of the first section to the base.

21. The assembly kit of claim 10, wherein the base comprises clearance take-up means configured to take up any clearance in the assembly direction.

22. The assembly kit of claim 21, wherein the clearance take-up means comprises tabs that extend from a rim of the base and that are bent in a direction opposite to the main direction, the tabs being configured to bear against the upper surface, and exert a force in a direction opposite to the assembly direction.

23. The assembly kit of claim 15, further comprising a disassembly wedge, the disassembly wedge comprising two mutually parallel main walls each provided with a free rim opposite a bottom of the disassembly wedge, the disassembly wedge being configured to be inserted, via its bottom, into a recess that opens out via one of the support surface or the assembly edge surface, the snap-fitting section being arranged vertically perpendicular to the recess, the disassembly wedge being further configured to adopt either a first position or a second position in the recess in the assembly direction, the first position being a position in which the free rims are held at a distance from the first sections, the second position being a position in which each free rim forces the first sections closer together so as to enable the snap-fitting means to be withdrawn in a direction opposite to the assembly direction.

24. The assembly kit of claim 23, wherein the disassembly wedge also comprises two lateral levers that extend from the bottom and in a direction from the bottom toward one of the free rims, each of the two lateral levers terminating in a tooth, the two teeth each extending in two opposing directions, the snap-fitting section also comprising two abutments each configured to cooperate with one of the teeth when the disassembly wedge is in its second position.

25. A method of assembling a partition on a support surface of a batten, the partition comprising two main surfaces that are substantially parallel and connected for a contour, the contour comprising at least three edge surfaces, the method using the assembly kit according to claim 10, and the method comprising:
attaching the clip on one of an edge surface, referred to as the assembly edge surface, or a support surface;
forming the snap-fitting section on the other of the assembly edge surface or the support surface; and
positioning the assembly edge surface of the partition opposite the support surface so as to engage the snap-fitting means in the opening.

26. The assembly method of claim 25, further comprising forming a recess in the batten, the recess opening out via the support surface, the method comprising the arrangement of a disassembly wedge in the recess, the snap-fitting section being arranged vertically perpendicular to the recess.
